(19) United States
(12) Patent Application Publication
(10) Pub. No.: US 2011/0055052 A1
(43) Pub. Date: Mar. 3, 2011

(54) System for Selectively Supplying Inventory to a Customer

(76) Inventors: James E. Issler, Greenwich, CT (US); Carmine Iandiorio, Greenwich, CT (US); Zhi Wu, Greenwich, CT (US)

(21) Appl. No.: 12/871,519

(22) Filed: Aug. 30, 2010

Related U.S. Application Data
(60) Provisional application No. 61/237,942, filed on Aug. 28, 2009.

(51) Int. Cl. G06Q 30/00; G06Q 10/00

(52) U.S. Cl. 705/27.1; 705/26.1

(57) ABSTRACT

The invention relates to a method and system for selectively providing inventory to an online retailer including an inventory database, a customer database, a computer in communication with the inventory database and customer database, software executing on the computer for retrieving inventory data from the inventory database, software executing on the computer for generating a product list containing one or more products to be made available for purchase by the customer, and software executing on the computer. for transmitting the product list to the customer. The software for generating the product list includes a graphical user interface, and the product list is generated based on the selection of products by a user via the graphical interface.

### CROSS-REFERENCE TO RELATED APPLICATIONS

The present application claims the benefit under 35 U.S.C. §119 (e) of the Provisional Patent Application Ser. No. 61/237,942 filed Aug. 28, 2009.

### FIELD OF THE INVENTION

The present invention relates to methods and systems for providing inventory to retailers. Specifically, the present invention relates to methods and systems for selectively providing inventory to an online retailer, wherein the inventory made available to the retailer is a subset of the total inventory owned by the supplier.

### BACKGROUND OF THE INVENTION

For suppliers of consumer products such as shoes, the internet has become a vital means of reaching the market. Many suppliers with a multi-tiered market approach utilize more than one e-commerce website to market their products. For example, a shoe company with a line of work boots and a line of women's fashion shoes may find that a separate website for each of these very different lines is the optimal way to make sales of products from each line. As another example, the supplier may have two lines of women's fashion shoes that are each directed at different market segments.

Many suppliers choose to sell their products to online retailers who, in turn, offer the supplier's products to the end-consumers. A supplier will often have many online retailers to which the supplier sells its products—with each online retailer desiring and being permitted access to different subsets of the supplier's total inventory. For example, an upscale online retailer may only want inventory from the supplier's line of upscale women's shoes. Meanwhile, the supplier may not want a lower-market online retailer to have access to the upscale shoe lines to maintain brand image/integrity. Suppliers desire control over how their products are marketed and sold by independent online retailers.

Additionally, with the advent of internet shopping, it is no longer necessary for a supplier to actually transfer its products to the possession of the online retailers. In some cases, the supplier can simply provide the online retailer with the information about the product that the retailer requires for listing the product on its website. Then, when an end-consumer finds a product he or she wishes to purchase on the online retailer's website, he or she places an order with the retailer and that order is transmitted to the supplier. The supplier completes the transaction by shipping the purchased product directly to the end-consumer. This technique is well-known and is most often referred to as “drop-shipping.”

What is desired, therefore, is an improved system for permitting a supplier to easily control the inventory made available to the supplier's online retailers. Another desire is a system wherein the inventory made available to the retailer is a subset of the total inventory owned by the supplier. A further desire is a system that provides a comprehensive list of products and associated product details to the online retailers to facilitate purchase of products by the retailers.

### SUMMARY OF THE INVENTION

It is therefore an object of the invention to provide a system and method which allows a supplier to easily and efficiently control the inventory made available to online retailers or customers, and wherein the inventory made available to the retailer is a subset of the total inventory owned by the supplier.

These and other objects of the invention are achieved by a system for selectively supplying inventory to a customer including an inventory database containing inventory data related to a plurality of products, a customer database containing customer data related to a plurality of customers, and a computer in communication with the inventory database and the customer database. The system also includes software executing on the computer for selecting a customer from the plurality of customers, software executing on the computer for retrieving inventory data from said inventory database, software executing on the computer for generating a product list containing one or more products from the plurality of products to be made available for purchase by the customer, and software executing on the computer for transmitting the product list to the customer. The software for generating the product list includes a graphical user interface, and generates the list based on the selection of products by a user via the graphical interface.

In certain embodiments, the system includes software executing on the computer for continuously analyzing and updating inventory data stored in the inventory database.

In some embodiments, the software for generating the product list and the graphical user interface are accessed by the user over the Internet.

In further embodiments, the system includes a webpage for displaying the plurality of products available for purchase by the customer. In certain embodiments, the system also includes software executing on said computer for creating an EDI file containing said list of products.

In some embodiments, the inventory database contains at least one product identifier for each of the plurality of products. In some of these embodiments, the at least one product identifier is selected from a group consisting of: style, color, width, and combinations thereof. In yet further embodiments, the product list contains the at least one product identifier for each of the products.

In another aspect of the invention, a method for selectively supplying an inventory to a customer is provided, including the steps of maintaining a customer database containing customer data related to a plurality of customers, maintaining an inventory database containing inventory data related to a plurality of products, selecting a customer from the plurality of customers, and retrieving inventory data from the inventory database. The method further includes the steps of generating a product list containing one or more products from the plurality of products to be made available for purchase by the selected customer based on a selection of products by a user, and transmitting the product list to the customer.

In certain embodiments, the method includes continuously updating the inventory database as products enter and leave inventory.

In other embodiments, the method also includes the step of displaying the product list containing one or more products available for purchase by the customer on a webpage accessible by the customer. In further embodiments, the method includes creating an EDI file containing the list of products.

In certain embodiments, the method includes retrieving at least one product identifier from the inventory database, the at least one product identifier selected from a group consisting of: style, color, width, and combinations thereof. In some of these embodiment, the method also includes the step of including the at least one product identifier in the product list.

Other objects of the invention and its particular features and advantages will become more apparent from consideration of the following drawings and accompanying detailed description.

### BRIEF DESCRIPTION OF THE DRAWINGS

FIG. 1 is a flow chart depicting flow of data in an embodiment of the present invention.

FIG. 2 is a block diagram depicting one embodiment of the system according to the present invention.

FIG. 3 is a screen shot from an embodiment of a system according to the present invention.

FIG. 4 is a screen shot from an embodiment of a system according to the present invention.

FIG. 5 is a flow chart depicting a method for providing the system shown in FIG. 2.

### DETAILED DESCRIPTION OF THE INVENTION

The present invention provides a novel system for permitting a supplier to easily control the inventory made available to the supplier's customers, called the Dynamic Feed Manager. The following is a general overview of the system. The supplier stores its products in inventory in one or more warehouses. The supplier maintains an electronic database of its inventory, which is constantly updated as products enter and leave the inventory. The supplier deals with a number of customers, such as online retailers, each of which purchases products from the supplier and then sells those products to end consumers. The supplier also maintains a database to store information related to these customers, including their identity, contact information, details about past transactions involving each customer, etc. The supplier maintains a server in communication with the inventory database and the customer database. The server runs software that enables the supplier to select a particular customer and to select the products in its inventory that the supplier will make available to that customer. The supplier then sends a list of products to the customer that the supplier has approved for sale by that retailer.

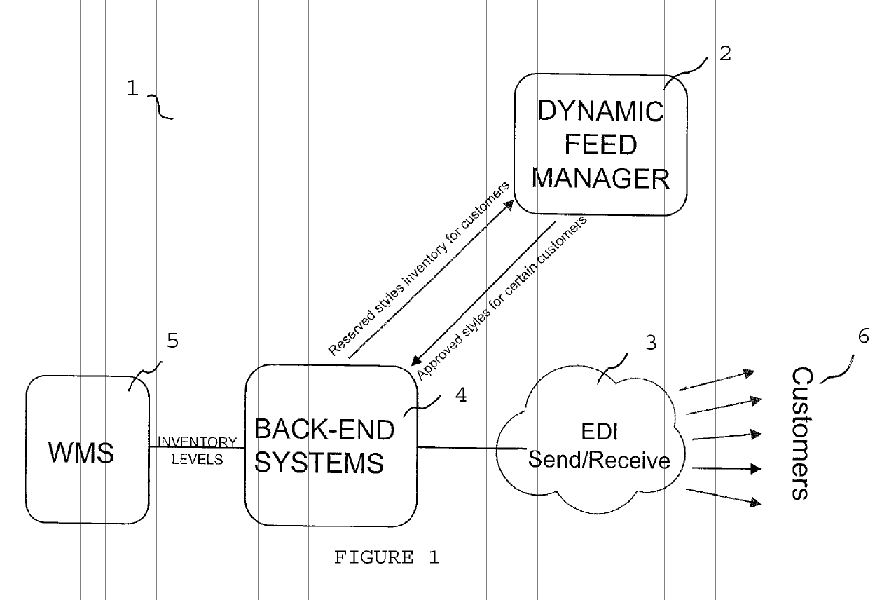

The flowchart shown in FIG. 1 is a general overview showing the flow of data in an embodiment of the system (1) for selectively supplying inventory to a customer in accordance with the present invention. In the upper part of the chart, Dynamic Feed Manager (2) is shown. In the embodiment shown in FIG. 1, the system utilizes EDI technology. As is well known in the art, “EDI” refers to Electronic Data Interchange, which involves the transmission of data between businesses by electronic means. However, it is understood that any other known technology may be used without departing from the spirit of the invention.

The Dynamic Feed Manager (2) sends and receives data both from and to the supplier's “back-end” product management systems (4). The supplier's “back-end” systems (4) have many functions, including, but not limited to, sending and receiving EDI files from the supplier's customers, such as online retailers. In some embodiments, the Dynamic Feed Manager (2) is a web-based program accessible by the supplier at any computer terminal that is suitably equipped and connected to the internet.

The supplier also maintains a warehouse management system (WMS) (5) shown schematically in the lower left hand corner of FIG. 1. The WMS (5) includes a database for storing data regarding the supplier's product inventory and tools for updating the database as products move into and out of the warehouse(s).

The data regarding inventory levels is transmitted from the WMS (5) to the Dynamic Feed Manager (2) via the supplier's back end systems (4). The warehouses contain the inventory of the supplier's products. In the present embodiment, only a subset of that inventory is intended to be available to the supplier's online retailers. In other embodiments, of course, the total inventory may be available for selection for sending to the online retailers.

The Dynamic Feed Manager (2) receives information from the back-end systems (4) about the inventory levels of products that have been reserved for the online retailers. The Dynamic Feed Manager (2) is accessible by individuals employed by the supplier, who then select which of the subset of products reserved for online retailers will be available to each individual online retailer. This selection of products from the subset is transmitted from the Dynamic Feed Manager (2) to the back-end system (4) as “approved styles for certain customers.” The back-end system (4) then creates an EDI file (3) including additional information about the selected products. For example, the EDI file (3) may contain a UPC number and quantity for each product being made available to each online retailer. This EDI file (3) is then sent to the online retailers (6).

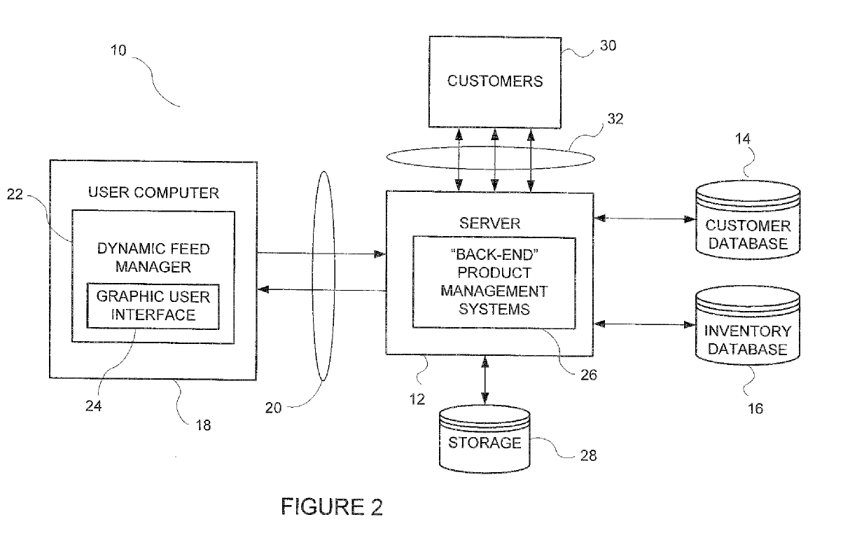

FIG. 2 is a block diagram more particularly depicting a system for selectively supplying inventory to a customer in accordance with an embodiment of the present invention. The system (10) generally comprises a customer database (14), an inventory database (16), and a server (12) coupled to the customer database and the inventory database. In some embodiments, the system further comprises a user computer (18) coupled to the server (12) via a network connection (20). It is contemplated that the network connection may comprise, for example, the Internet.

The customer database (14) contains data related to a plurality of customers with which the supplier conducts business. In certain embodiments, the customer database (14) also contains at least one customer identifier for each of the plurality of customers stored in the database. For example, the customer identifier may be customer's identity, contact information, or other customer related data. The customer database is directly connected to the server (12), or communicates with the server (12) via any suitable network connection, e.g., the Internet.

The inventory database (16) stores data related the supplier's product inventory. The inventory database communicates with the server (12) via any suitable network connection or is directly connected to the server (12). The list of products stored in the supplier's warehouse(s) and available for purchase by customers is entered into the inventory database (16). In some embodiments, the inventory database (16) includes tools for updating the database as products move into and out of the warehouse(s). In certain embodiments, the inventory database (16) also includes various product identifiers associated with each product. For example, the inventory database (16) may include product ID number, style, quantity, size, color, and/or width for each of the products in the inventory.

The server (12) includes various “back-end” product management systems (26). For example, in some embodiments, the server (12) comprises software executing on the server for sending to and receiving from the inventory. database (16) data related to products in the inventory, and for continuously analyzing and updating product data stored in the inventory database (16). In other embodiments, the server (12) also comprises software executing on the server for exchanging data with the customer database (14). It is appreciated that software is known in the art and any software that is capable of satisfying these requirements may be used in the system described herein.

In some embodiments of the present invention, the server (12) further comprises software for sending and receiving data from a plurality of the supplier's customers (30). The data may be transmitted to and from the customers (30) via any suitable means. In one advantageous embodiment of the present invention, the data is exchanged via Electronic Data Interchange (EDI) technology (32), which involves the transmission of data between businesses by electronic means.

The system (10) further includes Dynamic Feed Manager software (22). In the embodiment depicted in FIG. 2, the Dynamic Feed Manager (22) is installed on a user computer (18) and is connected to the server (12) via a network connection (20), such as the Internet. However, in other embodiments of the present invention, the Dynamic Feed Manager (22) runs directly on the server (12). The Dynamic Feed Manager (22) allows the supplier to retrieve and process data from the customer database (14) and the inventory database (16), and to select products in its inventory that the supplier will make available to each retailer.

The Dynamic Feed Manager (22) receives data from the server (12) about the inventory levels of products that have been reserved for the customers and customer data retrieved from the customer database.

The Dynamic Feed Manager (22) includes Graphic User Interface (GUI) (24), which is accessible by a user and which can execute on the user computer (18), as shown in FIG. 2, or on the server (12). The GUI (24) allows the user, e.g. supplier's employee, to manually select products from the inventory database and to create a product list containing one or more products from the plurality of products to be made available for purchase by a particular retailer. In some embodiments, the GUI (22) is presented to the user as a webpage having various user interface features. The product list may include additional information relating to each of the selected products, such as product ID, style, color, width, quantity, etc.

The product list is transmitted from the Dynamic Feed Manager (22) to the server (12) via the network (20). The server (12) then creates an EDI file including additional information about the selected products. This EDI file is then transmitted to the customers (30) via the network (32).

In some embodiments of the present invention, the server (12) further includes storage (28) for storing generated lists of products for retrieval at a later time. For example, the supplier may want to store a list of products available for purchase by a particular customer such that the supplier's employee may retrieve the list from the storage (28) and use the list as a template for generating a new list of products for that customer.

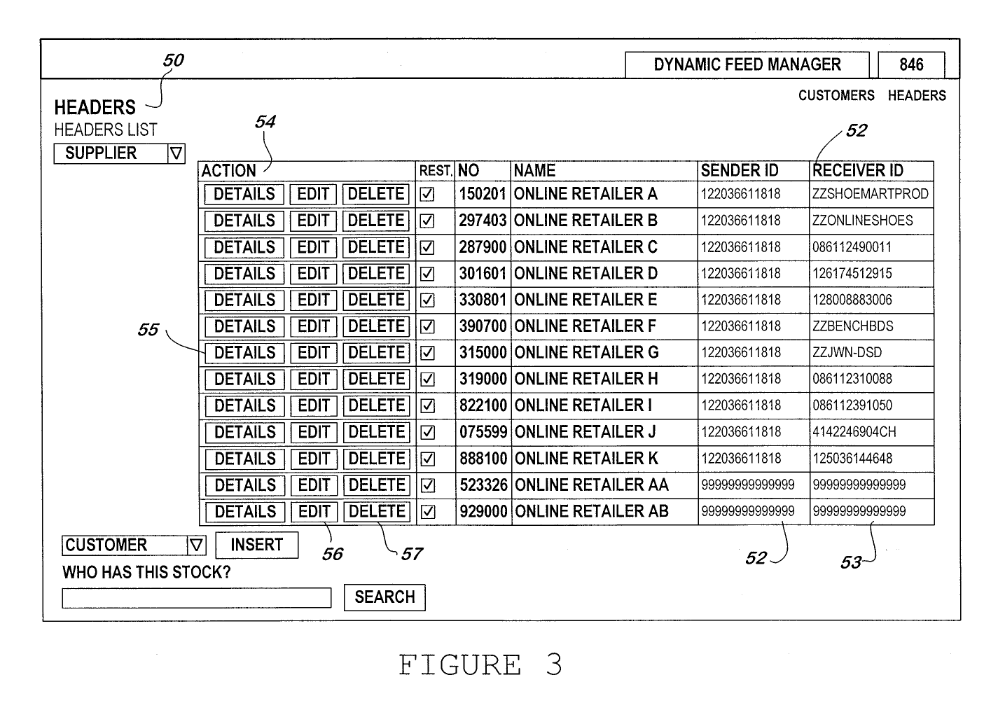

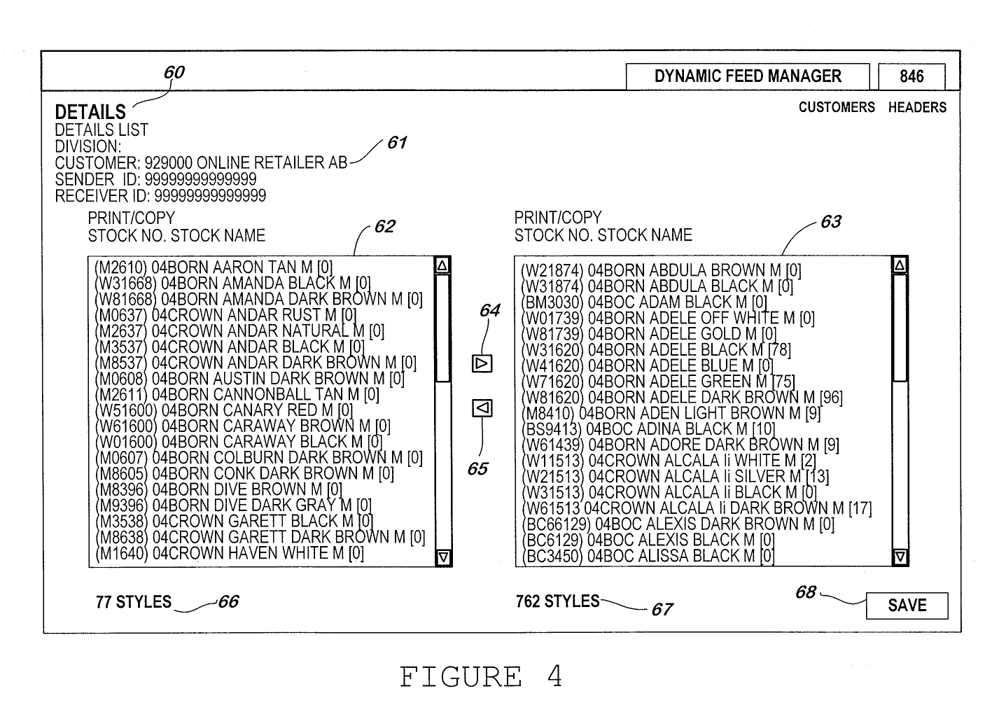

FIGS. 3-4 are screenshots taken from an embodiment of the Dynamic Feed Manager with the GUI in accordance with the present invention. FIG. 3 illustrates the “Headers” screen (50) displaying a plurality of online retailers (51) (Online Retailer A-Online Retailer AB). At this screen, a user, for example an employee of the retailer, can select the online retailer from the plurality of retailers (51) on whose account he or she wishes to work. The columns for “Sender ID” (52) and “Receiver ID” (53) show a plurality of codes associated with each online retailer for the transmission of EDI files.

In the “Action” column (54) shown in FIG. 3, there is a plurality of “Details” buttons (55), each associated with each online retailer. When a user clicks a “Details” button, he or she is then presented with the “Details” page shown in FIG. 4. The “Action” column (54) also includes a plurality of “Edit” buttons (56). If the user desires to supplement or change information relating to each retailer, he or she may click on the “Edit” button, which will direct the user to another page (not shown), whereby the user can make the desired changes. There is also a “Delete” button (57) associated with each retailer, whereby the user has an option of deleting a particular retailer from the database.

The “Details” page (60) depicted in FIG. 4 is an embodiment of the Graphic User Interface, through which an employee of the seller can select which of the products in the inventory will be made available to each online retailer. FIG. 4 shows a screenshot wherein the employee has selected Online Retailer AA (61). The list (62) shown on the left of the page contains all of the products in the supplier's inventory received from the inventory database that may be made available to an online retailer. The generated product list (63) on the right contains the products that the supplier has selected to be made available to the Online Retailer AA (61).

If the employee desires to move a product from the inventory list (62) on the left to the product list (63) on the right, he or she selects the product in the list on the left and clicks the right-arrow button (64) shown between the lists. If the employee wishes to remove a product from the product list (63) on the right, he or she simply selects the product and clicks the left arrow button (65). The label “77 styles” (66) at the bottom of the inventory list (62) on the left indicates the number of styles in inventory that have not been selected to be made available to Online Retailer AA. In this embodiment, this is the number of the subset of the total inventory that has been set aside for online retailers. The label “762 styles” (67) under the product list (63) on the right represents the number of products selected to be available to Online Retailer AA—essentially a subset of the subset that is particular to Online Retailer AA.

Once the employee of the supplier has finished populating the product list (63) on the right, he or she clicks the “Save” button (68). This causes the product list (63) to be transmitted to the server (12) and formatted into an EDI file for sending to the online retailer.

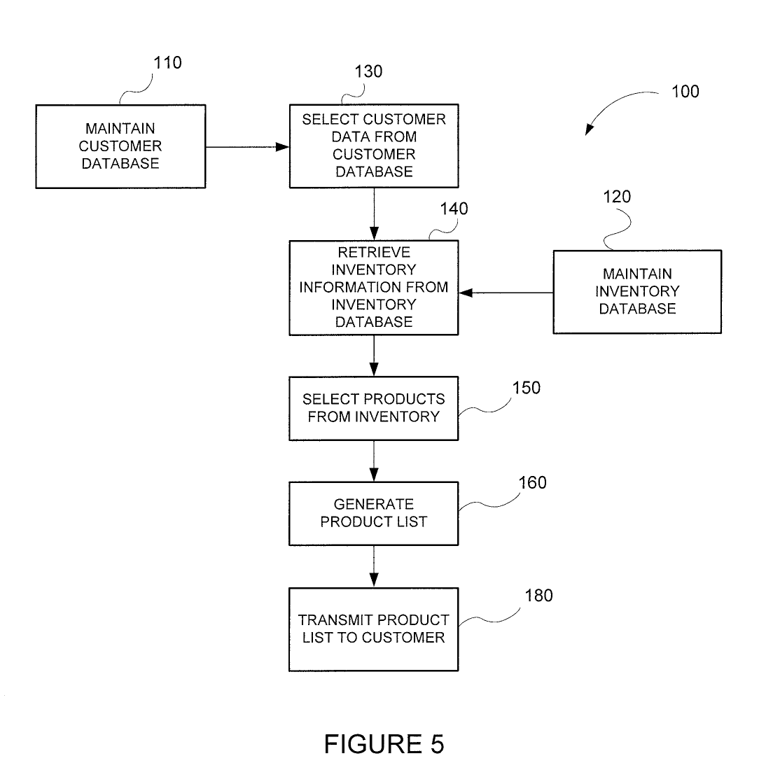

FIG. 5 depicts a method (100) for indicating customer information for a plurality of customers in accordance with an embodiment of the present invention. The method (100) includes the step of maintaining (120) an inventory database containing a list of products in the supplier's one or more warehouses available for purchase by the plurality of customers. The supplier may continuously update the inventory as the products enter and leave the warehouse(s). The method (100) also includes the step of maintaining (110) a customer database containing a plurality of customers with which the supplier conducts business. The customer database may also store information related to each of the plurality of customers, such as customer's identity, contact information, etc.

The method (100) further includes selecting (130) a customer from the customer database, retrieving (140) inventory information from the inventory database, and generating (160) a product list containing a plurality of products available for purchase by the selected customer. In the preferred embodiment, the product list is generated based on a selection (150) of products by a user. The product list may include additional information about each of the products on the list, such as product ID number, style, quantity, size, color, width, etc. The generated product list is then transmitted (180) to the customer via any suitable means, such as over the Internet or via EDI technology.

In some embodiments of the present invention, the method (100) may also include retrieving data related to the selected customer from the customer database. Such data includes customer's identity, contact information and other desired customer data.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A system for selectively supplying inventory to a customer, comprising:
an inventory database containing inventory data related to a plurality of products;
a customer database containing customer data related to a plurality of customers;
a computer in communication with said inventory database and said customer database;
software executing on said computer for selecting a customer from said plurality of customers;
software executing on said computer for retrieving inventory data from said inventory database;
software executing on said computer for generating a product list containing one or more products from said plurality of products to be made available for purchase by the selected customer, said software comprising a graphical user interface; and
software executing on said computer for transmitting said product list to the customer;
wherein said software for generating the product list generates said list based on the selection of products by a user via the graphical interface.

2. The system according to claim 1, further comprising software executing on said computer for continuously analyzing and updating inventory data stored in said inventory database.

3. The system according to claim 1, further comprising software executing on said computer for retrieving customer data from said customer database.

4. The system according to claim 1, further comprising a webpage for displaying said one or more products available for purchase by said customer.

5. The system according to claim 1, further comprising software executing on said computer for creating an EDI file containing said product list.

6. The system according to claim 1, wherein said inventory database contains at least one product identifier for each of the plurality of products.

7. The system according to claim 6, wherein said at least one product identifier is selected from a group consisting of: style, color, width, and combinations thereof.

8. The system according to claim 6, wherein said product list contains said at least one product identifier for each of the products.

9. The system according to claim 1, wherein said software for generating the product list and said graphical user interface are accessed by the user over the Internet.

10. The system according to claim 1, wherein said inventory data comprises a list of products available for purchase by said plurality of customers.

11. A method for selectively supplying an inventory to a customer, comprising the steps of:
maintaining a customer database containing customer data related to a plurality of customers;
maintaining an inventory database containing inventory data related to a plurality of products;
selecting a customer from said plurality of customers;
retrieving inventory data from said inventory database;
generating a product list containing one or more products from said plurality of products to be made available for purchase by the selected customer based on a selection of products by a user; and
transmitting said list of products to the customer.

12. The method according to claim 11, further comprising the step of retrieving customer data from said customer database.

13. The method according to claim 11, further comprising the step of continuously updating said inventory database as products enter and leave inventory.

14. The method according to claim 11, further comprising the step of displaying said product list containing one or more products available for purchase by the customer on a webpage accessible by said customer.

15. The method according to claim 11, further comprising the step of creating an EDI file containing said product list.

16. The method according to claim 11, further comprising the step of retrieving at least one product identifier from said inventory database, said at least one product identifier selected from a group consisting of: style, color, width, and combinations thereof.

17. The method according to claim 16, further comprising the step of including said at least one product identifier in said product list.
